(19) United States
(12) Patent Application Publication
(10) Pub. No.: US 2019/0197130 A1
(43) Pub. Date: Jun. 27, 2019

(54) ENSURING CONSISTENCY IN DISTRIBUTED INCREMENTAL CONTENT PUBLISHING

(71) Applicant: Microsoft Technology Licensing, LLC, Redmond, WA (US)

(72) Inventors: Shenghao Huang, Milpitas, CA (US); Nelson Mei, San Leandro, CA (US); Yogesh M. Upadhyay, Milpitas, CA (US); Allen Arista Reyes, Fremont, CA (US); Crystal Chen, Mountain View, CA (US); Curtis C. Seaton, Concord, CA (US); Bo Xing, Fremont, CA (US)

(73) Assignee: Microsoft Technology Licensing, LLC, Redmond, WA (US)

(21) Appl. No.: 15/850,507

(22) Filed: Dec. 21, 2017

(51) Int. Cl. G06F 17/30; H04L 9/06; H04L 29/08

(52) U.S. Cl. CPC G06F 17/3089; H04L 9/0637; G06F 17/30002; H04L 67/104; H04L 67/1097

(57) ABSTRACT

The disclosed embodiments provide a system for performing distributed incremental content publishing. The system includes a number of content sources and a message queue. Each content source receives or publishes an event containing a change to content over the message queue. When an event containing a change to content is received, a content source calculates a proof of work from the change. The content source then broadcasts the proof of work for verification by the other content sources. Alternatively, the content source receives the proof of work from another content source and verifies the proof of work. After the proof of work is verified, the content sources record the change by storing, in a blockchain, a block containing the change and the proof of work.

### BACKGROUND

### Field

The disclosed embodiments relate to content management systems. More specifically, the disclosed embodiments relate to techniques for ensuring consistency in distributed incremental content publishing.

### Related Art

Authors of articles, web pages, blogs, graphics, photos, audio, video, documents, reports, papers, and/or other digital content frequently use content management systems to create and publish the content. For example, a writer, developer, designer, researcher, and/or other type of author may select a template for creating a certain type of content within a content management system. Next, the author may use the template and features provided by the content management system to add text, images, audio, video, graphics, and/or other data to the content. After the author has finished creating the content, the author may use the content management system to publish the content to one or more servers, websites, and/or locations. The content management system may also allow the author to track edits to and/or versions of the content, manage permissions associated with the content, search for the content, and/or perform other management related to the content. Consequently, creation and distribution of digital content may be facilitated by improving the functionality and flexibility of content management systems.

### BRIEF DESCRIPTION OF THE FIGURES

FIG. 1 shows a schematic of a system in accordance with the disclosed embodiments.

FIG. 2 shows a system for performing distributed incremental content publishing in accordance with the disclosed embodiments.

FIG. 3 shows an exemplary set of blocks in a blockchain in accordance with the disclosed embodiments.

FIG. 4 shows a flowchart illustrating a process of performing distributed incremental content publishing in accordance with the disclosed embodiments.

FIG. 5 shows a flowchart illustrating a process of storing a block in a blockchain in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

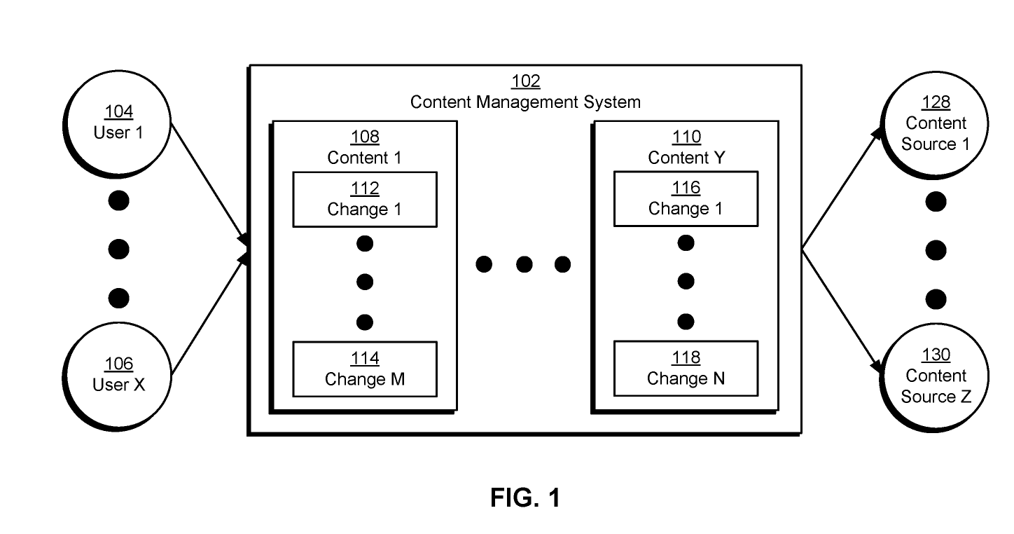

The disclosed embodiments provide a method and system for ensuring consistency during distributed incremental publishing of content. As shown in FIG. 1, a set of users (e.g., user 1 104, user x 106) may use a content management system (CMS) 102 to produce a set of content (e.g., content 1 108, content y 110). For example, the users may include writers, designers, illustrators, photographers, developers, musicians, architects, engineers, and/or other authors of digital content. The users may use CMS 102 to create, update, and/or publish images, video, audio, multimedia, documents, articles, blogs, web pages, computer aided design (CAD) drawings, architectural designs, logos, papers, and/or other types of digital content.

To create and/or modify content, the users may interact with multiple components in a user interface (e.g., graphical user interface, web-based user interface, etc.) of CMS 102 and/or multiple features within each component. Each component may be a module, frame, widget, workflow, toolbar, screen, window, and/or other grouping of user-interface elements that is related to a certain type of functionality within CMS 102. Features in the component may include tools, options, menu items, buttons, checkboxes, and/or other sub-components for performing specific actions and/or specifying settings during the content-creation process. For example, CMS 102 may include components for accessing templates; color, shape, and text tools; page settings and metadata tools; image-processing tools; review, markup, approval, or publishing tools; search-engine optimization (SEO) settings; grammar and spell-checking tools; and/or search tools.

After the content is created and/or published, changes to the content (e.g., change 1 112 to change m 114 in content 1 108, change 1 116 to change n in content y 110) may be tracked by CMS 102 and propagated to a number of content sources (e.g., content source 1 128, content source z 130). For example, a user may create an article using a user interface provided by CMS 102. After the article is complete, the user may publish the article through CMS 102. In turn, CMS 102 may replicate the published article across multiple servers, data centers, websites, databases, and/or other content sources connected to, associated with, and/or managed by CMS 102. In general, content sources in the CMS may include “authoring instances” that provide user-interface elements and/or other mechanisms for making changes to the content. The content sources may also, or instead, include “publishing instances” that publish the changes after the changes are made elsewhere (e.g., native, desktop, and/or mobile applications that implement the authoring instances and communicate with the publishing instances via network connections).

On the other hand, changes made to content in CMS 102 may fail to be propagated to the content sources in a reliable, consistent, scalable, and/or fully distributed way. For example, a change to published content may be generated or received at one content source and transmitted to the other content sources using a messaging platform and/or another communications mechanism. A content source that fails to receive the change over the communications mechanism may thus have a copy of the content that is inconsistent with other copies of the content. In another example, changes to content may be received at a single master database at one content source and replicated to a set of slave databases at the other content sources. As a result, the master database may be a performance bottleneck in saving and propagating the changes across the content sources.

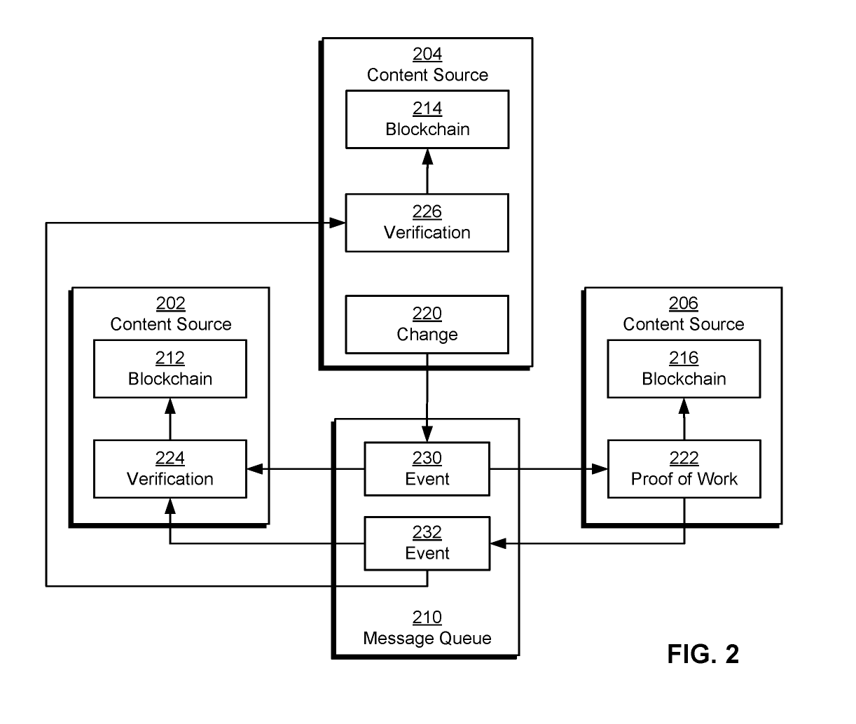

In one or more embodiments, CMS 102 includes functionality to replicate changes to content across the content sources in a way that is fully distributed, reliable, and consistent. As shown in FIG. 2, a CMS (e.g., CMS 102 of FIG. 1) may include a number of content sources 202-206. Each content source 202-206 may maintain a separate copy of content in the CMS. For example, content sources 202-206 may each have a separate database and/or other data store for storing content that is created and/or published in the CMS. Moreover, changes to the content may be made and/or received at any content source and propagated to the other content sources. As a result, changes to the content may be replicated and/or published in a fully distributed fashion instead of configuring one content source and/or data store as a master and replicating content changes from the master to other content sources and/or data stores that are configured to operate as slaves.

To ensure consistency in replicating content changes across content sources 202-206, the CMS may store and/or verify the changes using blockchains 212-216 that are maintained at each content source. Each blockchain may contain a series of linked blocks that track changes to the content in a cryptographically secure way. For example, each change may be encoded with a timestamp of the change and/or a nonce in a hash value, and the hash value may be stored with the change, timestamp, and/or nonce in a block. The block may then be appended to the end of the blockchain by including the hash value for the previous block in the block and/or encoding the blocks and hashes into a hash tree.

More specifically, content sources 202-206 use a message queue 210 to transmit, verify, and commit changes to content in the CMS. First, a change 220 to the content is made and/or received at a given content source 204. For example, a user may generate change 220 by saving, publishing, and/or modifying an article, document, blog post, image, audio, video, multimedia, paper, web page, CAD drawing, design, logo, and/or another type of content through a user interface of the CMS. In turn, change 220 may be received at content source 204 based on the proximity of content source 204 to the user, a connection between the user and content source 204 through the CMS, and/or other criteria. In another example, change 220 may be received by content source 204 from message queue 210 after the user makes change 220 at a different location (e.g., an “authoring instance” of the CMS).

Next, content source 204 broadcasts an event 230 containing change 220 to message queue 210, and other content sources 202 and 206 receive event 230 over message queue 210. For example, content sources 202-206 may use a distributed streaming platform such as Apache Kafka (Kafka™ is a registered trademark of the Apache Software Foundation) to send and receive messages over one or more topics and/or partitions representing message queue 210. Within the distributed streaming platform, each content source may both produce and consume messages related to content changes in the CMS in an asynchronous manner. By decoupling transmission of the messages by the producers from receipt of the messages by the consumers, the distributed streaming platform may allow topics, streams, message queues, producers, and/or consumers to be dynamically added, modified, replicated, scaled, and/or removed without interfering with the transmission and receipt of messages using other topics, streams, producers, and/or consumers.

In one or more embodiments, event 230 includes a description of change 220 and/or metadata associated with change 220. For example, events containing content changes (e.g., event 230) may be sent and received over message queue 210 using the following schema:

```
{
  “name”: “ReplicationEvent”,
  “type”: “record”,
  “doc”: “This event is sent when content is replicated”,
  “namespace”: “com.linkedin.messages.croft”,
  “fields”: [
  {
      “name”: “auditHeader”,
      “type”: “com.linkedin.events.KafkaAuditHeader”,
      “doc”: “Header used to audit the data in the kafka pipeline.”
  },
  {
      “name”: “contentPath”,
      “type”: “string”,
      “doc”: “The path of the content in the repository.”
  },
  {
    “name”:“replicationEventType”,
    “type”:
  {
    “name”: “ReplicationEventType”,
    “type”: “enum”,
    “symbols”: [“CREATED”, “DELETED”]
    },
    “doc”: “The type of replication event.”
  },
  {
    “name”: “payload”,
    “type”: [ “null”, “bytes”],
    “doc”: “Serialized payload of the replicated content”
  }
  ]
}
```

In the above schema, each event containing a content change may have a set of fields, including an “auditHeader” that is used to audit data in message queue 210 (e.g., a Kafka pipeline), a path of the content affected by the change, a type of change (i.e., creation or deletion), and a “payload” containing an optional description of the change and/or the actual change.

After event 230 is received by content sources 202 and 206 (and optionally content source 204) over message queue 210, the content sources may use data in event 230 to calculate a proof of work 222 from change 220. For example, each content source may calculate proof of work 222 as a SHA-256 hash and/or other type of hash value from change 220, a timestamp representing the time at which change 220 was made, a monotonically increasing nonce, and/or other data or metadata from event 230. Proof of work 222 may further be associated with a difficulty requirement such as a minimum number of leading or trailing zeros and/or other required values in the hash value. As a result, each content source may be required to find a nonce that, when hashed with other values in event 230, produces proof of work 222 as a hash value that satisfies the difficulty requirement.

As shown in FIG. 2, content source 206 produces proof of work 222 before other content sources 202-204 in the system. Content source 206 also broadcasts proof of work 222 in an event 232 that is sent over message queue 210 to the other content sources 202-204. In turn, content sources 202-204 use event 232 to perform independent verifications 224-226 of proof of work 222. For example, event 232 may contain proof of work 222 and the corresponding data used to produce proof of work 222 (e.g., message digest of change 220, nonce, timestamp, identifier of event 230, etc.). Each content source may verify that the hash value represented by proof of work 222 satisfies the difficulty requirement and is calculated using the nonce and corresponding data for change 220.

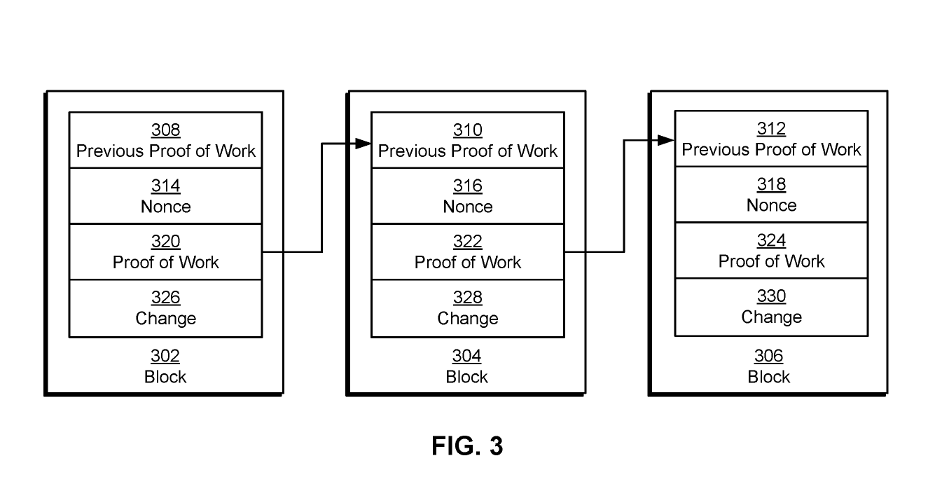

If verifications 224-226 confirm that proof of work 222 is valid, content sources 202-204 may commit and/or record change 220 to their corresponding databases and/or data stores by adding change 220 and proof of work 222 to blockchains 212-214. For example, each content source may create a block containing change 220, proof of work 222, and/or other values used to calculate proof of work 222 (e.g., nonce, timestamp, additional hashes, other metadata, etc.). The content source may append the block to the end of the corresponding blockchain by adding the block to a linked list storing the blockchain and/or including, in the block, a previous proof of work from the previous block in the blockchain. Managing blocks in blockchains is discussed in further detail below with respect to FIG. 3.

One or more verifications 224-226 may optionally be transmitted in messages or events over message queue 210 as indications that proof of work 222 is valid. In turn, content source 206 may commit and/or record change 220 to its database and/or data store by adding the corresponding block to the end of blockchain 206.

Alternatively, verifications 224-226 may indicate that proof of work 222 is invalid. For example, content sources 202-204 may determine that the hash value representing proof of work 222 is not calculated from the corresponding data used to produce proof of work 222. Content sources 202-204 may also, or instead, determine that the hash value does not satisfy the difficulty requirement for proofs of work in the system. As a result, content sources 202-204 may continue calculating proof of work 222 and/or transmit messages or events over message queue 210 indicating that event 232 contains an invalid proof of work 222.

Once a content source finishes calculating proof of work 222, the content source may broadcast proof of work 222 for subsequent verification by the other content sources. In turn, change 220 may be propagated across the CMS after a certain number of content sources 202-206 verify proof of work 222 and add blocks containing change 220, proof of work 222, a previous proof of work, and/or other related data to the corresponding blockchains 212-216.

By using blockchains 212-216 to store and/or publish content in a distributed CMS, the system of FIG. 2 may allow incremental changes to the content to be received at any content source in the CMS and replicated to the other content sources in a reliable and consistent way. In turn, the system may streamline the synchronization of content across the CMS and/or the configuration of the CMS as a decentralized, distributed system. Consequently, the system may improve computer systems and/or technologies for performing decentralized content distribution, content management, content publishing, and/or content versioning.

Those skilled in the art will appreciate that the system of FIG. 2 may be implemented in a variety of ways. First, content sources 202-206 and message queue 210 may be provided by a single physical machine, multiple computer systems, one or more virtual machines, a grid, one or more databases, one or more filesystems, and/or a cloud computing system. Content sources 202-206 and message queue 210 may additionally be implemented together and/or separately by one or more hardware and/or software components and/or layers.

Second, content sources 202-206 and/or message queue 210 may be scaled to the amount of content created and/or published using the CMS and/or the number of users of the CMS. For example, additional content sources may be added to and/or connected to the CMS to allow publication of content to different websites and/or other locations. In another example, messages containing content changes, proofs of work, and/or other events that are used to reliably propagate and verify the content changes across the content sources may be sent over multiple message queues representing different types of content, teams of content producers, actions related to the content (e.g., creation, review, publication, modification, deletion, etc.), and/or other groupings or categories associated with content in the CMS. In a third example, multiple instances of message queue 210 may be replicated across data centers and/or other locations to allow communication among content sources in the data centers and/or locations.

Those skilled in the art will also appreciate that the system of FIG. 2 may be adapted to other types of functionality. For example, the reliable and consistent synchronization or replication of data across distributed nodes may be adapted to collaborative editing or development tools, wikis, distributed databases, and/or other mechanisms for sharing or updating content.

FIG. 3 shows an exemplary set of blocks 302-306 in a blockchain (e.g., blockchains 212-216 of FIG. 2) in accordance with the disclosed embodiments. As mentioned above, blocks 302-306 may be used to securely track, commit, and/or record changes 326-330 to content within a CMS and/or another system for distributing or publishing content.

Each change 326-330 may be received at a content source in the system, such as a server, website, database, and/or other location at which the content is stored and can be retrieved and/or modified. For example, changes 326-330 may include content (e.g., text, images, audio, video, documents, source code, webpages, articles, blog posts, graphics, logos, advertisements, etc.), modifications to the content (e.g., differences between an old version and a new version of the content), and/or metadata describing the content or modifications (e.g., changing the color of a button or other user-interface element from red to blue).

Blocks 302-306 are linked within the blockchain according to the order in which the corresponding changes 326-330 were received by a content source. For example, the first block in the blockchain may be a “dummy” block to which subsequent blocks 302-306 are appended. In turn, blocks 302-306 may hold a series of changes 326-330 to a given content item in the system. As a result, changes 326-330 may be applied according to the ordering of the corresponding blocks 302-306 within the blockchain to construct the latest version of the content. Older versions and/or snapshots of the item may similarly be constructed by sequentially applying a subset of changes up to a given point before the last block in the blockchain.

Blocks 302-306 include additional data elements for securing and verifying the replication of changes across content sources in the system. First, each block 302-306 includes a proof of work 320-324 that is calculated from the corresponding change 326-330 and a nonce 314-318. As discussed above, each content source may work on calculating the proof of work after broadcasting or receiving an event, message, and/or other communication containing a corresponding content change (e.g., changes 326-330). After a content source completes the calculation, the content source may broadcast the proof of work in a subsequent event, message, and/or other communication for verification by the other content sources. In turn, the other content sources may verify the proof of work and commit the content change by adding a block containing the content change, nonce, and proof of work to the blockchain. Alternatively, the other content sources may continue calculating the proof of work if the verification fails. In other words, the change may be committed to the system only after the proof of work has been calculated by a content source and verified to be valid by some or all of the other content sources.

Proofs of work 320-324 may be calculated as hash values and/or other values that satisfy a difficulty requirement, such as SHA-256 hashes that have a certain number of leading zeros and/or other required values. To generate proofs of work 320-324 that satisfy the difficulty requirement, the content sources may be required to search for values of nonces 314-318 that, when combined with the corresponding changes 326-330 and/or other associated values (e.g., timestamps of the changes, other components of blocks 302-306, other hash values, etc.), produce hashes that meet the target difficulty. Moreover, nonces 314-318 used to calculate consecutive proofs of work 320-324 may be continuously increasing to track the ordering of the corresponding content changes 326-330 and/or blocks 302-306 in the blockchain.

To further link blocks 302-306 in a specific order within the blockchain, each block may include a previous proof of work (e.g., previous proofs of work 308-312) from a previous block in the blockchain. For example, previous proof of work 310 in block 304 may store the value of proof of work 320 from block 302, and previous proof of work 312 in block 306 may store the value of proof of work 322 from block 304.

In turn, previous proofs of work 308-312 may be used to maintain and/or validate the ordering of blocks 302-306 in the blockchain and/or another data structure that is used to store and/or verify blocks 302-306 (e.g., Merkle tree, linked list, etc.). For example, each proof of work (e.g., proofs of work 320-324) published by a content source may be accompanied by the content source's previous proof of work to allow the other content sources to verify both the validity of the newly published proof of work and the ordering of the most recent blocks in the content source's blockchain.

Those skilled in the art will appreciate that multiple versions of the blockchain may exist when multiple blocks are created at substantially the same time at different content sources. For example, two content sources “A” and “B” may broadcast two different content changes and/or proofs of work at the same time and/or within a certain interval (e.g., a number of seconds) of one another. As a result, some content sources may store one version of the blockchain that includes the change from content source “A” before the change from content source “B,” while other content sources may store a different version of the blockchain that includes the change from content source “B” before the change from content source “A.” The different versions of the blockchain may further produce two conflicting versions of the content (i.e., one version in which the change from “A” is applied before the change from “B” and another version in which the change from “B” is applied before the change from “A”).

To detect conflicts in blockchains and/or the ordering of content changes 326-328 across the system, each content source may compare the previous proof of work (e.g., previous proofs of work 308-312) published with a newly calculated proof of work (e.g., from another content source) with the content source's most recent proof of work (i.e., from the latest block in the content source's blockchain). In turn, the content source may find a conflict when the newly published proof of work has a previous proof of work that differs from the content source's most recent proof of work.

The content sources may also, or instead, transmit and/or store other information that can be used to detect and/or resolve conflicts in the ordering of blocks 302-306 and/or the corresponding changes 326-330 committed in blocks 302-306. For example, each content source may be configured to publish, with a newly calculated proof of work, a length of the locally stored blockchain that includes the new proof of work. Each block (e.g., blocks 302-306) in a given content source's blockchain may additionally or alternatively store the length of the blockchain up to that block. Thus, the length of the blockchain included with a newly published proof of work may be compared to the length of the blockchain at a given content source to determine if the system includes two or more conflicting blockchains.

To resolve conflicting blockchains and/or versions of content in the system, the content sources may select the longer of two conflicting sub-chains for inclusion in the blockchain. Moreover, the longer sub-chain may be selected after the difference in length exceeds a threshold. For example, content sources in the system may maintain multiple versions of the blockchain until one version is determined to be longer than the others by a pre-specified amount (i.e., a certain number of blocks). After a given content source identifies the longest valid blockchain, the content source may broadcast and/or communicate the longest valid blockchain to the other content sources so that the content sources can verify the blockchain, resolve the conflict, and reach consensus with one another.

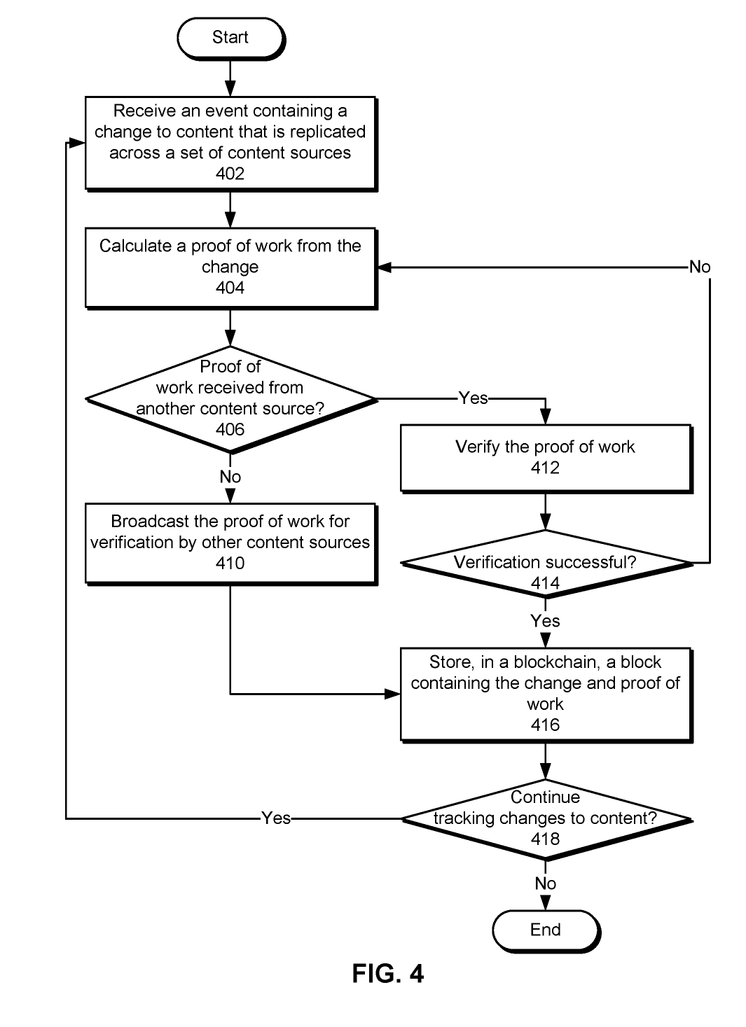

FIG. 4 shows a flowchart illustrating a process of performing distributed incremental content publishing in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, an event containing a change to content that is replicated across a set of content sources is received (operation 402). For example, the event may be broadcasted by one content source to the other content sources using a message queue and/or another communications mechanism. The content sources may form a CMS and/or another system for storing, publishing, replicating, and/or distributing content.

Next, a proof of work is calculated from the change (operation 404). For example, each content source may work on calculating a proof of work such as a hash value that is calculated from the change, an incrementing nonce, and/or other data or metadata related to the change. The proof of work may additionally be associated with a difficulty requirement, such as a certain number of leading zeros, trailing, and/or other required values in the hash.

While a given content source calculates the proof of work, the proof of work may be received from another content source (operation 406). Continuing with the previous example, the content source may receive the proof of work from the message queue after the other content source identifies a nonce that, when combined with the change and/or other associated data, results in a hash that meets the difficulty requirement.

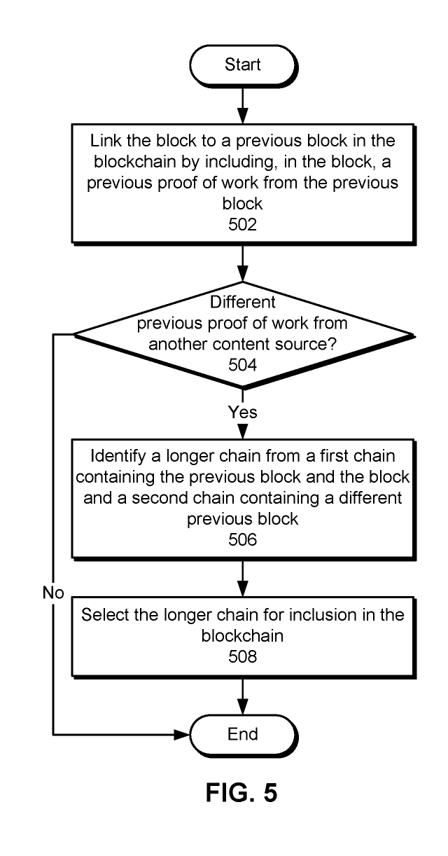

Alternatively, the content source broadcasts the proof of work for verification by the other content sources (operation 410) if the content source is the first to calculate the proof of work. The content source also stores, in a blockchain, a block containing the change and proof of work (operation 416) to commit and/or record the change at the content source. In turn, the content source may construct the latest version of the content by applying changes stored in the blockchain in the order of the corresponding blocks. Storing blocks in blockchains and/or resolving conflicts in blockchains are described in further detail below with respect to FIG. 5.

If the proof of work is received from another content source, the proof of work is verified (operation 412). Continuing with the previous example, the proof of work may be transmitted with the nonce and/or other data required to produce the proof of work. In turn, the verification may be performed by confirming that the corresponding hash meets the difficulty requirement and is produced from the change, nonce, and/or associated data.

The proof of work may then be processed based on the success or failure of the verification (operation 414). If the verification succeeds, the change and proof of work are stored in a block within the blockchain (operation 416). If the verification fails, the content source continues to calculate the proof of work (operation 404) until a valid proof of work is produced by the content source and/or another content source and stored in a block within the blockchain (operations 406-416).

Changes to the content may continue to be tracked (operation 418) using the blockchain. For example, the blockchain may be used to securely replicate each incremental change to the content across the content sources. In turn, each content change may be published and/or received in an event (operation 402), and a proof of work is calculated and used to securely commit the change to the blockchain (operations 404-416). Such distributed incremental content publishing may thus continue until the content sources are no longer used to store, publish, and/or replicate the content.

FIG. 5 shows a flowchart illustrating a process of storing a block in a blockchain in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, the block is linked to a previous block in the blockchain by including, in the block, a previous proof of work from the previous block (operation 502). For example, the block may be stored in a blockchain that is maintained by a content source. To link the block to the previous block, the block may include a hash or other previous proof of work that is calculated from a number of other data elements in the previous block. The block may also include a change to content, a nonce, and/or a proof of work that is calculated from the change and the nonce, as discussed above.

A different previous proof of work for the block may be received from another content source (operation 504). For example, the other content source may publish the proof of work for the block with the different previous proof of work. Because the two previous proofs of work differ, multiple conflicting versions of the blockchain may exist in the content sources. If the other content source does not have a different previous proof of work for the block, no conflict is found, and no additional steps are required to store the block in the blockchain.

If conflicting blockchains are detected from differing previous proofs of work in the content sources and/or other data (e.g., differing lengths of the blockchains), a longer chain is identified from a first chain containing the previous block and a second chain containing a different previous block (operation 506). For example, the two chains may include different previous blocks that are represented by the previous proofs of work identified in operations 502-504. The longer chain may also be identified after the difference in length between the two chains exceeds a threshold, such as a pre-specified number of blocks. After the longer chain is identified, the longer chain is selected for inclusion in the blockchain (operation 508). For example, content sources that lack the longer chain may extract “source information” from metadata in messages used to establish the longer chain and obtain blocks in the longer chain from the content source represented by the source information. In turn, blocks in the shorter chain are discarded to allow the content sources to reach consensus on the blockchain and corresponding content changes.

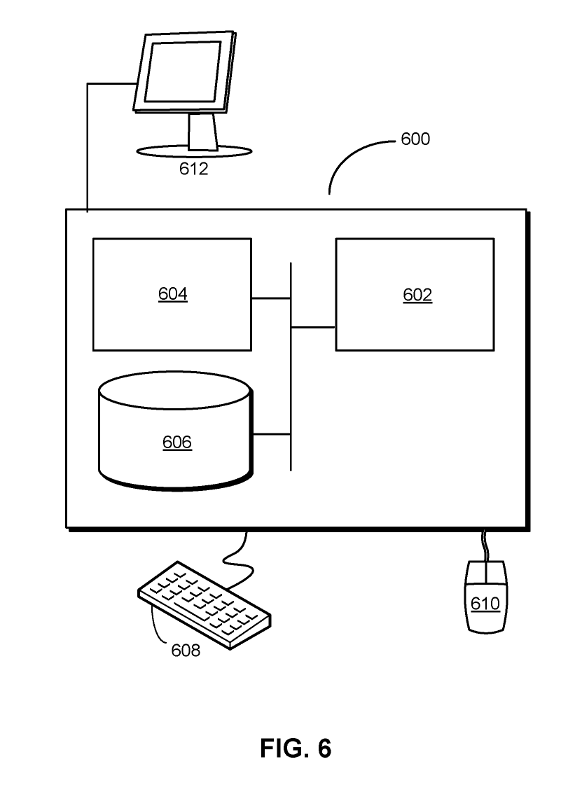

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for performing distributed incremental content publishing. The system includes a number of content sources and a message queue. Each content source receives or publishes an event containing a change to content over the message queue. When an event containing a change to content is received, a content source calculates a proof of work from the change. The content source then broadcasts the proof of work over the message queue for verification by the other content sources. Alternatively, the content source receives the proof of work from another content source and verifies the proof of work. After the proof of work is verified, the content sources commit the change by storing, in a blockchain, a block containing the change and the proof of work.

In addition, one or more components of computer system 600 may be remotely located and connected to the other components over a network. Portions of the present embodiments (e.g., content sources, message queue, CMS, etc.) may also be located on different nodes of a distributed system that implements the embodiments. For example, the present embodiments may be implemented using a cloud computing system that verifies and commits content and/or changes to content from a set of remote content sources and/or users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
receiving a first event comprising a first change to content that is replicated across a set of content sources;
calculating, by a computer system associated with a content source in the set of content sources, a first proof of work from the first change;
broadcasting, by the computer system, the first proof of work for verification by other content sources in the set of content sources; and
recording, by the computer system, the first change in the content by storing, in a blockchain, a first block comprising the first change and the first proof of work.

2. The method of claim 1, further comprising:
receiving a second event comprising a second change to the content;
during calculation of a second proof of work from the second change, receiving the second proof of work from another content source in the set of content sources; and
upon verifying the received second proof of work, recording the second change by storing, in the blockchain, a second block comprising the second change and the second proof of work.

3. The method of claim 2, wherein verifying the received second proof of work comprises:
verifying that the second proof of work meets a difficulty requirement and is calculated from the second change and a nonce received with the second proof of work.

4. The method of claim 1, wherein storing the first block in the blockchain comprises:
linking the first block to a previous block in the blockchain by including a previous proof of work from the previous block in the first block.

5. The method of claim 4, wherein storing the first block in the blockchain further comprises:
upon receiving a different previous proof of work for the first block from another content source, identifying a longer chain from a first chain comprising the previous block and the first block and a second chain comprising another previous block containing the value and the first block; and
selecting the longer chain for inclusion in the blockchain.

6. The method of claim 5, wherein identifying the longer chain comprises:
determining that a difference in length between the first chain and the second chain exceeds a threshold prior to selecting the longer chain from the first and second chains.

7. The method of claim 1, further comprising:
receiving a second event comprising a second change to the content;
during calculation of a second proof of work from the second change, receiving the second proof of work from another content source in the set of content sources; and
when the received second proof of work fails verification, continuing to calculate the second proof of work from the second change.

8. The method of claim 1, wherein calculating the first proof of work from the first event comprises:
selecting a nonce for the first proof of work;
calculating a hash from the nonce and the first change; and
verifying that the hash satisfies a difficulty requirement.

9. The method of claim 8, wherein the nonce is selected to be larger than a previous nonce from a previous proof of work.

10. The method of claim 8, wherein the first block further comprises:
the nonce; and
the previous proof of work.

11. The method of claim 1, wherein the first event is received over a message queue.

12. The method of claim 1, wherein set of the content sources is included in a content management system.

13. A method, comprising:
receiving a first event comprising a first change to content that is replicated across a set of content sources;
calculating, by a computer system associated with a content source in the set of content sources, a first proof of work from the first change;
during calculation of the first proof of work, receiving the first proof of work from another content source in the set of content sources; and
upon verifying the received first proof of work, recording the first change by storing, in the blockchain, a first block comprising the first change and the first proof of work.

14. The method of claim 13, further comprising:
receiving a second event comprising a second change to the content;
calculating a second proof of work from the second change;
broadcasting the second proof of work for verification by other content sources in the set of content sources; and
recording the second change in the content by storing, in the blockchain, a second block comprising the second change and the second proof of work.

15. The method of claim 13, wherein verifying the received first proof of work comprises:
verifying that the first proof of work meets a difficulty requirement and is calculated from the first change and a nonce received with the first proof of work.

16. The method of claim 13, wherein storing the first block in the blockchain comprises:
linking the first block to a previous block in the blockchain by including a previous proof of work from the previous block in the first block.

17. The method of claim 16, wherein storing the first block in the blockchain further comprises:
upon receiving a different previous proof of work for the first block from another content source, identifying a longer chain from a first chain comprising the previous block and the first block and a second chain comprising another previous block containing the value and the first block; and
selecting the longer chain for inclusion in the blockchain.

18. The method of claim 16, wherein the first block further comprises:
a nonce; and
the previous proof of work.

19. A non-transitory computer-readable storage medium storing instructions that when executed by a computer cause the computer to perform a method, the method comprising:
receiving a first event comprising a first change to content that is replicated across a set of content sources;
calculating a first proof of work from the first change;
broadcasting the first proof of work for verification by other content sources in the set of content sources; and
recording the first change in the content by storing, in a blockchain, a first block comprising the first change and the first proof of work.

20. The non-transitory computer-readable storage medium of claim 19, the method further comprising:
receiving a second event comprising a second change to the content;
during calculation of a second proof of work from the second change, receiving the second proof of work from another content source in the set of content sources; and
upon verifying the received second proof of work, recording the second change by storing, in the blockchain, a second block comprising the second change and the second proof of work.
